(19) United States
(12) Patent Application Publication
(10) Pub. No.: US 2010/0026679 A1
(43) Pub. Date: Feb. 4, 2010

(54) Booster circuit, display panel driver, and display device

(75) Inventor: Hirofumi Fujiwara, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/458,967

(22) Filed: Jul. 28, 2009

(30) Foreign Application Priority Data
Jul. 29, 2008 (JP) 2008-194668

(51) Int. Cl. G09G 5/00; G05F 1/10

(52) U.S. Cl. 345/214; 327/536

(57) ABSTRACT

A booster circuit is provided with a boosting section and a control circuitry. The boosting section includes a boosting capacitor element and is configured to perform charging operation to accumulate charges across the boosting capacitor element and to perform boosting operation to boost an output voltage by using charges accumulated in the boosting capacitor element. The control circuitry controls the boosting section to alternately perform the charging and boosting operations in response to a boosting clock signal and the output voltage. The control circuitry prohibits performing the charging and boosting operations in response to whether a selected line of dot pixels is an odd-numbered line or an even-numbered line in a display panel.

### INCORPORATION BY REFERENCE

This application claims the benefit of priority based on Japanese Patent Application No. 2008-194668, filed on Jul. 29, 2008, the disclosure of which is incorporated herein by reference.

### BACKGROUND OF THE INVENTION

1. Field of the Invention

The present invention relates to a booster circuit and a display panel driver and display device incorporating the same.

2. Description of the Related Art

Panel display devices, such as a TFT (Thin Film Transistor) liquid crystal display device, a simple matrix liquid crystal display device, an electroluminescence (EL) display device and a plasma display device, have achieved widespread use. Such a display device is provided with a display panel and a display panel driver for driving the display panel in response to display data. When a panel display device is installed within a portable device, the panel driver often incorporates a charge pump power supply circuit. The power supply circuit generates a boosted power supply voltage generated from a voltage fed from a battery etc., and supplies the generated power supply voltage to the driver.

Japanese Laid Open Patent Application No. JP-A 2000-166220 discloses a power supply circuit incorporating a charge pump circuit. The disclosed power supply circuit is provided with a charge pump booster which receives an input voltage Vin and a boosting clock signal CLKA and boosts the input voltage Vin to a predetermined output voltage Vout. This charge pump booster includes a switch circuitry for performing a switching operation in response to the boosting clock signal. The power supply circuit further has a boosting controller, a comparator, and a voltage divider circuit. The comparator compares a divided voltage generated by the voltage divider circuit with a control voltage, and outputs an output signal indicating the comparison result. The boosting controller performs a logic processing on the output signal and an operation clock signal, and generates the above-mentioned boosting clock signal.

In this circuit, the frequency of the boosting clock signal is changeable, because of the operation in which the boosting clock signal is fixed to the (L) level when pulses of the operation clock signal are skipped in response to the divided voltage. Therefore, the switching operation of the booster circuit is performed at undefined frequencies.

Since the frequency of the switching operation of this disclosed booster circuit is undefined, being not in a fixed cycle, the switching operation is asynchronous to the horizontal synchronization signal fed to the a driver which drives a display panel. This undesirably causes noise resulting from the switching operation of the switch circuitry, deteriorating the image quality of the image displayed on the display panel, when the boosted voltage (the output voltage Vout) of the above-mentioned power supply circuit is used as the power supply of the amplifier circuit and the grayscale voltage generator circuit in the driver.

### SUMMARY

In an aspect of the present invention, a booster circuit is provided with a boosting section and a control circuitry. The boosting section includes a boosting capacitor element and is configured to perform charging operation to accumulate charges across the boosting capacitor element and to perform boosting operation to boost an output voltage by using charges accumulated in the boosting capacitor element. The control circuitry controls the boosting section to alternately perform the charging and boosting operations in response to a boosting clock signal and the output voltage. The control circuitry prohibits performing the charging and boosting operations in response to whether a selected line of dot pixels is an odd-numbered line or an even-numbered line in a display panel.

In another aspect of the present invention, a driver is provided with: a booster circuit outputting a boosted output voltage; a grayscale voltage generator operating on the boosted output voltage to generate a set of grayscale voltages; a digital-analog converter selecting output grayscale voltages corresponding to display data from the set of grayscale voltages; and an amplifier circuit operating on the boosted output voltage to output the selected output grayscale voltages to a display panel. The booster circuit includes: a boosting section comprising a boosting capacitor element, the boosting section configured to perform charging operation to accumulate charges across the boosting capacitor element and to perform boosting operation to boost the output voltage by using charges accumulated in the boosting capacitor element; and a control circuitry controlling the boosting section to alternately perform the charging and boosting operations in response to a boosting clock signal and the output voltage. The control circuitry prohibits performing the charging and boosting operations in response to whether a selected line of dot pixels is an odd-numbered line or an even-numbered line in a display panel.

In still another aspect of the present invention, a display device is provided with: a booster circuit outputting a boosted output voltage; a driver; and a display panel. The driver includes: a grayscale voltage generator operating on the boosted output voltage to generate a set of grayscale voltages; a digital-analog converter selecting output grayscale voltages corresponding to display data from the set of grayscale voltages; and an amplifier circuit operating on the boosted output voltage to output the selected output grayscale voltages to a display panel. The booster circuit includes: a boosting section comprising a boosting capacitor element, the boosting section configured to perform charging operation to accumulate charges across the boosting capacitor element and to perform boosting operation to boost the output voltage by using charges accumulated in the boosting capacitor element; and a control circuitry controlling the boosting section to alternately perform the charging and boosting operations in response to a boosting clock signal and the output voltage. The control circuitry prohibits performing the charging and boosting operations in response to whether a selected line of dot pixels is an odd-numbered line or an even-numbered line in a display panel.

In still another aspect of the present invention, a method of voltage boosting includes:

alternately performing a charging operation to accumulate charges across a boosting capacitor element and a boosting operation to boost an output voltage by using charges accumulated in the boosting capacitor element in response to a boosting clock signal and the output voltage; and

prohibiting performing the charging and boosting operations in response to whether a selected line of dot pixels is an odd-numbered line or an even-numbered line in a display panel.

In the present invention, charging and boosting operations are performed only when odd-numbered lines are selected or when odd-numbered lines are selected. That is, charging and boosting operations are performed for half of the lines of the display panel. This effectively reduces noise resulting from the switching of switches within the booster circuit.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows an exemplary configuration of a TFT liquid crystal display device in one embodiment of the present invention;

FIG. 2 shows an exemplary configuration of a source driver of the TFT liquid crystal display device in one embodiment of the present invention;

FIG. 3 shows the configuration of the source driver of the TFT liquid crystal display device shown in FIG. 2;

FIG. 4 shows an exemplary configuration of a booster circuit of the source driver of the TFT liquid crystal display device in one embodiment of the present invention;

FIG. 5 is a truth table showing an exemplary operation of a line number signal output circuit of a pulse skipping operation controller of the booster circuit of the source driver of the TFT liquid crystal display device in one embodiment of the present invention;

FIG. 6A is a timing chart showing an exemplary pulse skipping operation of the booster circuit of the source driver of the TFT liquid crystal display device in one embodiment of the present invention; and

FIG. 6B is a timing chart showing another exemplary pulse skipping operation of the booster circuit of the source driver of the TFT liquid crystal display device in one embodiment of the present invention.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

In the following, a description is given of a display device incorporating a booster circuit of one embodiment of the present invention with reference to the attached drawings. It should be noted that the present invention may be applied to various display devices such as a TFT (Thin Film Transistor) liquid crystal display device, a simple matrix liquid crystal display device, an electroluminescence (EL) display device, and a plasma display device.

### <Overall Configuration>

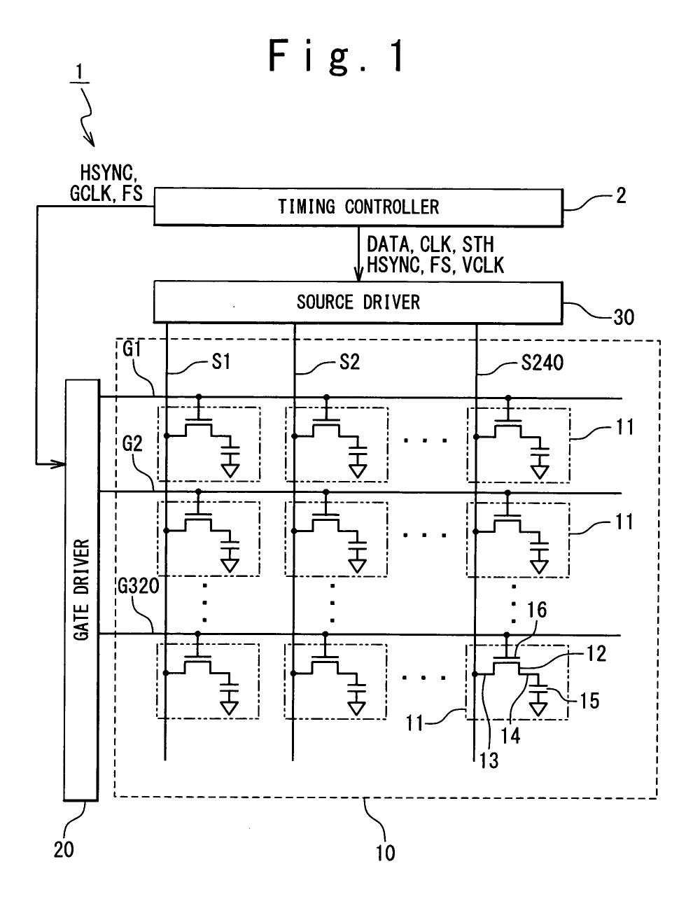

FIG. 1 shows an exemplary configuration of a TFT liquid crystal display device 1 in one embodiment of the present invention.

The TFT liquid crystal display device 1 of this embodiment is provided with a liquid crystal display panel 10. Hereinafter, a description is given with an assumption that the liquid crystal display panel 10 is a QVGA panel which incorporates 240×320 pixels. The liquid crystal display panel 10 is provided with dot pixels 11 arranged in rows and columns. The dot pixels 11 each include a thin film transistor (TFT) 12 and a pixel capacitor 15. The pixel capacitors 15 are formed by pixel electrodes and a counter electrode facing the pixel electrodes. The counter electrode is connected to a counter electrode driver (not shown). The TFTs 12 each have a drain electrode 13, a source electrode 14 connected to the pixel electrodes, and a gate electrode 16. For example, when the liquid crystal display panel 10 is a monochromatic panel, dot pixels 11 are arranged in 240 columns and 320 lines. One the other hand, when the liquid crystal display panel 10 is a multicolor panel, each pixel is composed of three dot pixels for displaying red (R), green (G), and black (B), respectively, and 720 (=240×3) dot pixels 11 are arranged in each line in the horizontal direction of the liquid crystal display panel 10. FIG. 1 illustrates the system configuration for the case where the liquid crystal display panel 10 is a monochromatic panel for convenience.

The TFT liquid crystal display device 1 further includes gate lines G1 to G320 and data lines S1 to S240. The gate lines G1 to G320 are connected to the gate electrodes 16 of the TFTs 12 of the dot pixels 11 arranged in 320 rows (lines), respectively. The data lines S1 to S240 are connected to the drain electrodes 13 of the TFTs 12 of the dot pixels 11 arranged in 240 columns, respectively.

The TFT liquid crystal display device 1 additionally includes a gate driver 20 and a source driver 30 for driving the dot pixels 11. The gate driver 20 is integrated within a semiconductor chip (not illustrated) and is connected to the gate lines G1 to G320. The source driver 30 is integrated within another semiconductor chip and is connected to the data lines S1 to S240.

Furthermore, the TFT liquid crystal display device 1 includes a timing controller 2. For the use in a portable device, the timing controller 2 is usually integrated within one IC chip with one or more other circuits. In one embodiment, the timing controller 2 and the source driver 30 may be monolithically integrated. In an alternative embodiment, the timing controller 2, the source driver 30 and the gate driver 20 may be monolithically integrated.

The timing controller 2 outputs a horizontal synchronization signal HSYNC for indicating each horizontal period, and a gate clock signal GCLK for sequentially selecting the gate lines G1 to G320. The gate driver 20 sequentially outputs selection signals to the respective gate lines G1 to G320 in respective horizontal periods (selecting the gate line G1) in response to the gate clock signal GCLK and the horizontal synchronization signal HSYNC. When a selection signal is fed to the gate electrodes 16 of the TFTs 12 of the 240 dot pixels 11 in the selected line, and the corresponding TFTs 12 are turned on by the selection signal.

The timing controller 2 outputs a frame switch signal FS for indicating the switching of the image frames. The frame switch signal FS is activated when the current frame data for the current image frame displayed on the liquid crystal display panel 10 is switched to next frame data for the next image frame. The frame data include the display data DATA for the complete set of the lines. In this embodiment, the gate clock signal GCLK, the horizontal synchronization signal HSYNC, and the frame switch signal FS, which are fed from the timing controller 2 to the gate driver 20, are activated after the gate driver 20 selects the gate line G320. In this case, the gate driver 20 then selects the gate line Gl in response to the gate clock signal GCLK, the horizontal synchronization signal HSYNC, and the frame switch signal FS.

The timing controller 2 sequentially feeds the display data DATA for the respective lines to the source driver 30. In addition, the timing controller 2 feeds a clock signal CLK, a boosting clock signal VCLK, and a shift pulse signal STH to the source driver 30. It should be noted that details of the configuration and operation of the source driver 30 will be described later.

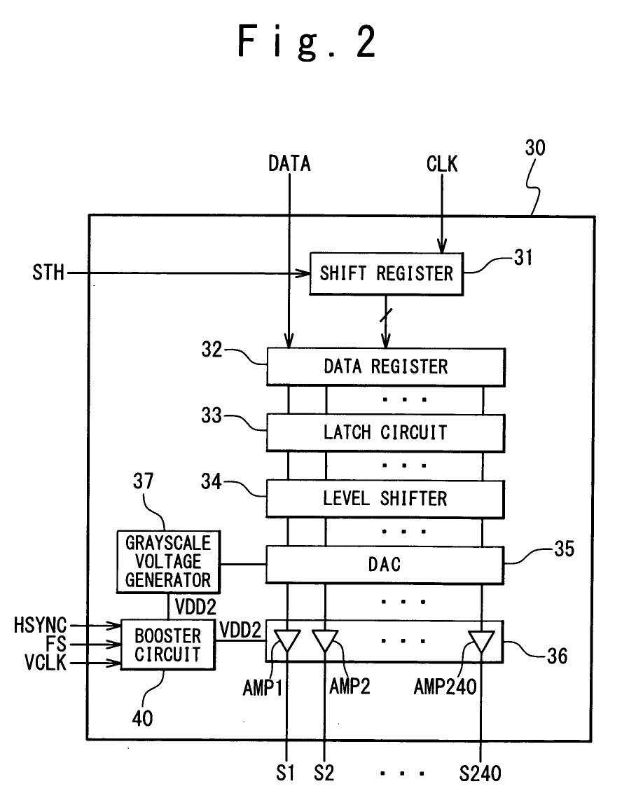

FIG. 2 shows an exemplary configuration of the source driver 30.

The source driver 30 includes a shift register 31, a data register 32, a latch circuit 33, a level shifter 34, a digital-analog converter (DAC) 35, an amplifier circuit 36, a grayscale voltage generator circuit 37, and a booster circuit 40 (or power supply circuit 40). The amplifier circuit 36 incorporates amplifiers AMP1 to AMP240 having outputs connected to data lines S1 to S240, respectively.

The booster circuit 40 supplies an output boosted voltage VDD2 higher than the power supply voltage VDD to the amplifier circuit 36 and the grayscale voltage generator circuit 37. The amplifier circuit 36 operates on the output boosted voltage VDD2 fed to an output voltage supply node N_{VDD2} from the booster circuit 40.

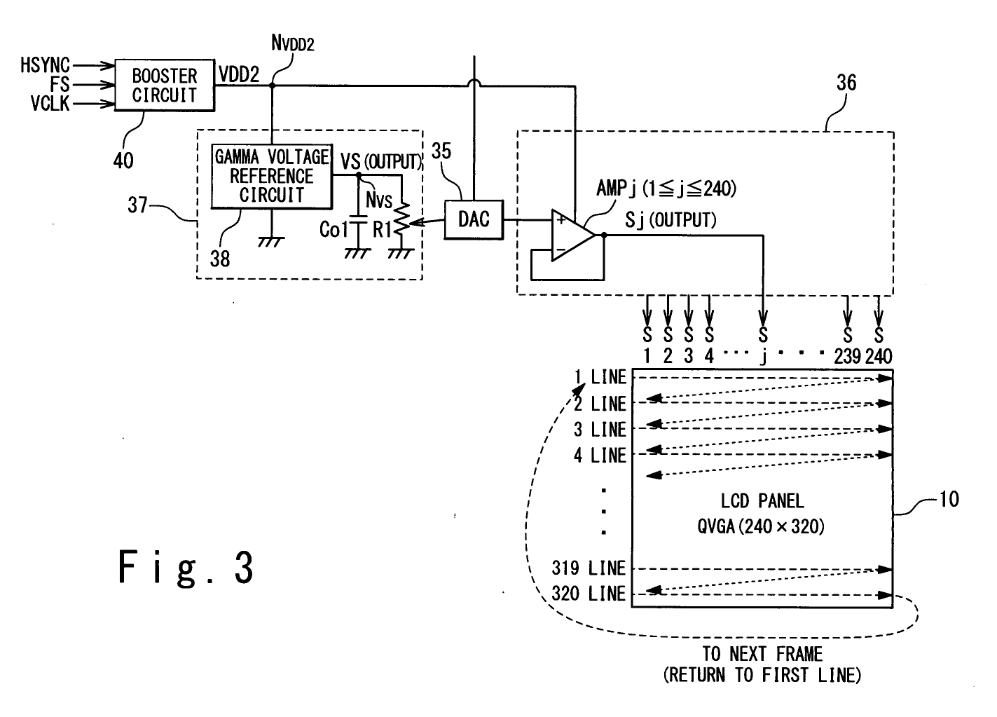

As shown in FIG. 3, the grayscale voltage generator circuit 37 includes a gamma correction voltage reference circuit 38, a gamma correction resistor ladder R1, and a capacitor element Co1.

The gamma correction voltage reference circuit 38 is connected between a ground line and the output voltage supply node N_{VDD2} to which the booster circuit 40 feeds the output voltage VDD2. The grayscale voltage generator circuit 37 allows the gamma correction voltage reference circuit 38 to generate a gamma correction reference voltage VS (0<VS<VDD2) from the output voltage VDD2 fed to the output voltage supply node N_{VDD2}, and supplies the gamma correction reference voltage VS to the gamma correction resistor ladder R1 for generating a set of grayscale voltages.

The capacitor element Co1 is connected between the ground line and a gamma correction reference voltage supply node N_{VS} to which the gamma correction voltage reference circuit 38 supplies the gamma correction reference voltage VS. The gamma correction resistor ladder R1, which is connected between the gamma correction reference voltage supply node N_{VS} and the ground line, includes serially-connected grayscale resistor elements (not illustrated). The grayscale voltage generator circuit 37 generates a set of grayscale voltages by dividing the gamma correction reference voltage VS fed to the gamma correction reference voltage supply node N_{VS} by using the serially-connected grayscale resistor elements, and supplies the generated grayscale voltages to the DAC 35. For the case where the TFT liquid crystal display device 1 performs 64-level grayscale display, for example, the grayscale voltage generator circuit 37 divides the gamma correction reference voltage VS with 63 grayscale resistor elements to generate 64 different grayscale voltages associated with 64 grayscale levels, respectively, and supplies the generated grayscale voltages to the DAC 35.

Referring back to FIG. 2, an exemplary operation of the source driver 30 will be explained.

The booster circuit 40 alternately performs charging and boosting operations. In the charging operation, the booster circuit 40 accumulates electric charges corresponding to the power supply voltage across a capacitor element. In the boosting operation, the booster circuit 40, in response to the boosting clock signal VCLK from the timing controller 2, generates the output boosted voltage VDD2 by adding the power supply voltage and the voltage corresponding to electric charges accumulated across the capacitor element, and supplies the output boosted voltage VDD2 to the amplifier circuit 36 and the grayscale voltage generator circuit 37.

The grayscale voltage generator circuit 37 generates the gamma correction reference voltage VS from the output voltage VDD2 fed from the booster circuit 40 by the gamma correction voltage reference circuit 38. In addition, the grayscale voltage generator circuit 37 generates the set of grayscale voltages by dividing the gamma correction reference voltage VS by the gamma correction resistor ladder R1 and supplies the set of grayscale voltages to the DAC 35.

The shift register 31 performs a shifting operation of the shift pulse signal STH therewithin to generate a set of latch signals to the data register 32. The latch signals are sequentially activated in synchronization with the clock signal CLK.

The data register 32 sequentially receives the display data DATA from the timing controller 2 in synchronization with the latch signals from the shift register 31. The data register 32 has a capacity for the display data DATA for one line (that is, the display data DATA for 240 dot pixels 11). The latch circuit 33 latches a complete set of the display data for one line at the same time from the data register 32, and transfers the latched display data to the level shifter 34. The level shifter 34 provides level conversion for the display data received from the latch circuit 33, respectively, and transfers the display data to the DAC 35. The DAC 35 performs digital/analog conversion by selecting an output grayscale voltage corresponding to each of the display data received from the level shifter 34 from among the set of grayscale voltages fed from the grayscale voltage generator circuit 37. The DAC 35 feeds the 240 output grayscale voltages, each of which is subjected to digital/analog conversion, to the amplifier circuit 36.

The amplifiers AMP1 to AMP240 in the amplifier circuit 36 provide impedance transformation on the 240 output grayscale voltages received from the DAC 35, and output the impedance-transformed grayscale voltages to the data lines S1 to S240 to drive the 240 dot pixels 11 of the selected line of the liquid crystal display panel 10, respectively. For example, the TFTs 12 of the 240 dot pixels 11 associated with the gate line G1 are turned on, when the gate line G1 is selected. In this case, 240 pieces of the display data are written in the pixel capacitors 15 of the 240 dot pixels 11 associated with the selected line, respectively, and are held until the next display data writing.

The booster circuit 40, which outputs the output voltage VDD2 exceeding the withstand voltage of low-voltage elements, are constituted with high-voltage elements that have a higher withstand voltage than that of low-voltage elements to avoid a problem of the withstand voltage, where the low-voltage element means a MOS transistor that has a shortest channel length available in the manufacture process, whereas the high-voltage element means a MOS transistor structured to have a layout size larger than that of the low-voltage element for the same amplification factor (hfe) or manufactured by adopting a longer channel length or applying additional dedicated to the high-voltage elements.

However, the high-voltage element has demerits of an increased layout size of each element compared with the low-voltage element, which undesirably causes increases in the chip size and manufacture cost. For this reason, it is desired that the booster circuit 40 uses low-voltage elements as much as possible. In order to satisfy this need, a pulse skipping operation is implemented to limit the output voltage so that the output voltage does not exceed the withstand voltage of low-voltage elements, when low-voltage elements are used in the booster circuit 40. The pulse skipping operation means that the above-mentioned boosting and charging operations are halted, when the output voltage (the output voltage VDD2) is increased up to or above a desired voltage.

The pulse skipping operation is achieved in the booster circuit 40 by halting the switching operation of switches (details of the switching operation are described later). However, the pulse skipping operation results in that the booster circuit 40 performs the switching operation at undefined frequencies, not at a fixed frequency; the pulse skipping operation makes the switching operation of the booster circuit 40 asynchronous to the horizontal synchronization signal HSYNC. Therefore, when the output voltage VDD2 is used as a power supply voltage of the amplifier circuit 36 and the grayscale voltage generator circuit 37, noise caused by the switching operation of the switches within the booster circuit 40 may be observed as the image deterioration on the liquid crystal display panel 10. The TFT liquid crystal display device 1 of this embodiment is designed to reduce noise caused by the pulse skipping operation by the configuration and operations described in the following.

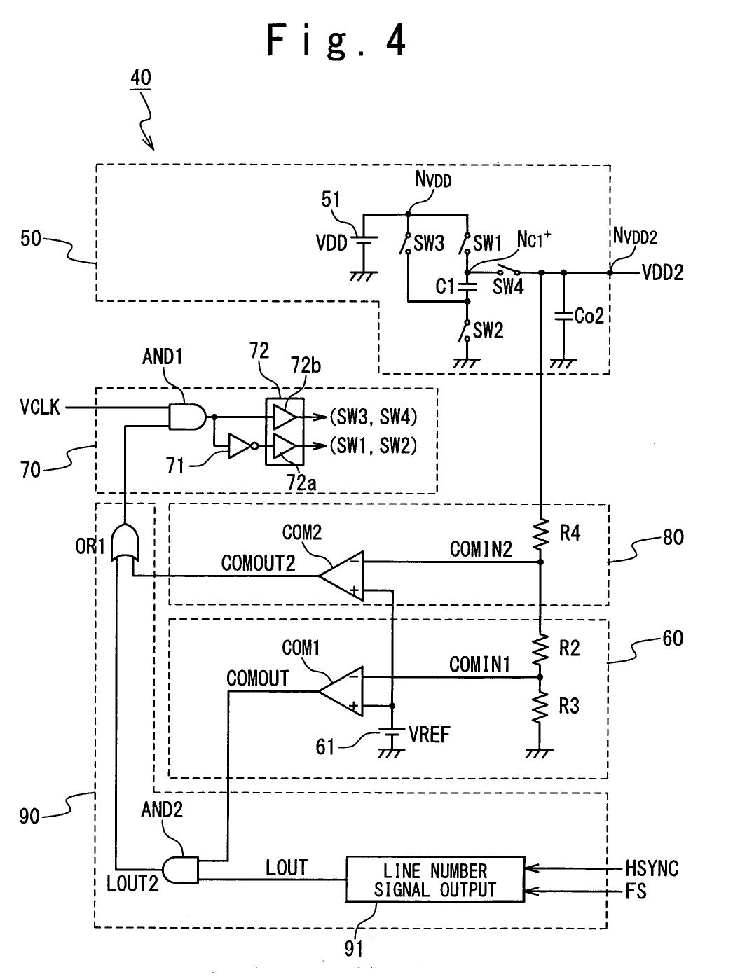

FIG. 4 shows an exemplary configuration of the booster circuit 40.

The booster circuit 40 includes a booster section 50, voltage comparator sections 60, 80, a boosting controller section 70, and a pulse skipping operation controller section 90. The voltage comparator sections 60, 80, the boosting controller section 70, and the pulse skipping operation controller section 90 form a control circuitry which controls the booster section 50.

The booster section 50 includes a power supply 51, switches SW1 to SW4, a boosting capacitor element C1 and a smoothing capacitor element Co2. The power supply 51 feeds the power supply voltage VDD to the power supply node N_{VDD}. The switches SW1 and SW2 are low-voltage elements, which are MOS transistors each having a gate fed with an inverted boosting control signal that is generated by inverting a boosting control signal. The switches SW1 and SW2 are turned on when the signal level of the inverted boosting control signal is set to the high level (H).

The switches SW3 and SW4 are low-voltage elements which are MOS transistors each having a gate fed with the boosting control signal. The switches SW3 and SW4 are turned on when the signal level of the boosting control signal is set to the high level (H). The switch SW2 is connected between the power supply node N_{VDD} and a ground line. The switch SW1 is connected between the power supply node N_{VDD} and the switch SW2. The boosting capacitor element C1 is connected between the switches SW1 and SW2. The switch SW3 is connected between the power supply node N_{VDD} and the switch SW2. The switch SW4 is connected between a positive capacitor node NC1+ and the above-mentioned output voltage supply node N_{VDD2}, where the positive capacitor node NC1+ is provided between the switch SW1 and the boosting capacitor element C1. The capacitor element Co2 is connected between the output voltage supply node N_{VDD2} and the ground line.

The voltage comparator section 60 includes a reference voltage supply 61, a comparator COM1, and serially-connected resistor elements R2 and R3. The resistor element R3 is connected between the output voltage supply node N_{VDD2} and a ground line, and a resistor element R2 is connected between the output voltage supply node N_{VDD2} and the resistor element R3. The comparator COM1 has a non-inverting input terminal, an inverting input terminal, and an output terminal. The reference voltage supply 61 is connected between the non-inverting input terminal of the comparator COM1 and a ground line, and supplies the reference voltage VREF to the non-inverting input terminal. The reference voltage VREF is a predetermined positive voltage. The inverting input terminal of the comparator COM1 is connected to the connection node of the resistor elements R2 and R3 to receive a divided voltage COMIN generated by voltage dividing with the resistor elements R2 and R3.

The voltage comparator section 80 is provided with a comparator COM2 and a resistor element R4. The resistor element R4 is connected between the output voltage supply node N_{VDD2} and the resistor element R2. The comparator COM2 has a non-inverting input terminal, an inverting input terminal, and an output terminal. The non-inverting input terminal of the comparator COM2 is connected to the reference voltage supply 61, and the reference voltage supply 61 supplies thereto the reference voltage VREF. The inverting input terminal of the comparator COM2 is connected to the connection node of the resistor elements R4 and R2 to receive a divided voltage COMIN2 generated by voltage dividing with the resistor elements R4, R2 and R3.

The pulse skipping operation controller section 90 is provided with a line number signal output circuit 91, an AND circuit AND2, and an OR circuit OR1. The inputs of the line number signal output circuit 91 are connected to the timing controller 2 to receive the horizontal synchronization signal HSYNC and the frame switch signal FS from the timing controller 2. The AND circuit AND2 has two input terminals and an output terminal. The output of the line number signal output circuit 91 is connected to one of the two input terminals of the AND circuit AND2, and the line number signal output circuit 91 supplies an output signal LOUT to the one input terminal. The other input terminal of the AND circuit AND2 is connected to the output terminal of the comparator COM1. The OR circuit OR1 has two input terminals and an output terminal. One input terminal of the two input terminals of the OR circuit OR1 is connected to the output terminal of the AND circuit AND2. The other input terminal of the OR circuit OR1 is connected to the output terminal of the comparator COM2.

The boosting controller section 70 has an AND circuit AND1, an inverter 71, and a level shift circuit 72. The AND circuit AND1 has two input terminals and an output terminal, and the inverter 71 has an input terminal and an output terminal. The level shift circuit 72 is provided with a first level shifter 72a which provides level-shifting for the inverted boosting control signal fed to the switches SW1 and SW2, and a second level shifter 72b which provides level-shifting for the boosting control signal fed to the switches SW3, SW4. One input terminal of the two input terminals of the AND circuit AND1 is connected to the timing controller 2, and the timing controller 2 supplies the boosting clock signal VCLK to the one input terminal. The other input terminal of the AND circuit AND1 is connected to the output terminal of the OR circuit OR1, and the output signal of the OR circuit OR1 is fed to the other input terminal of the AND circuit AND1. The output terminal of the AND circuit AND1 is connected to the input of the second level shifter 72b of the level shift circuit 72 and the input terminal of the inverter 71. The output terminal of the inverter 71 is connected to the input of the first level shifter 72a of the level shift circuit 72.

### <Booster Circuit Operation>

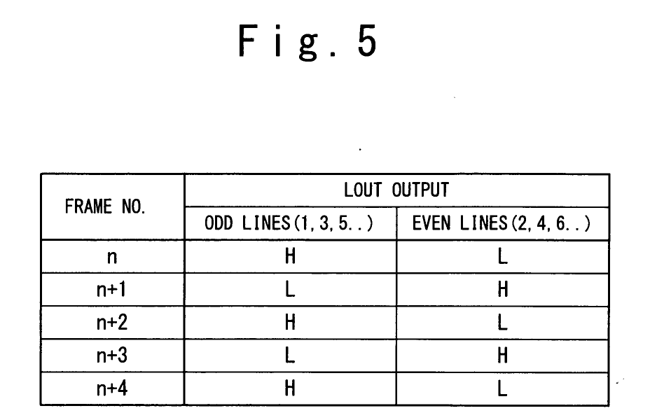

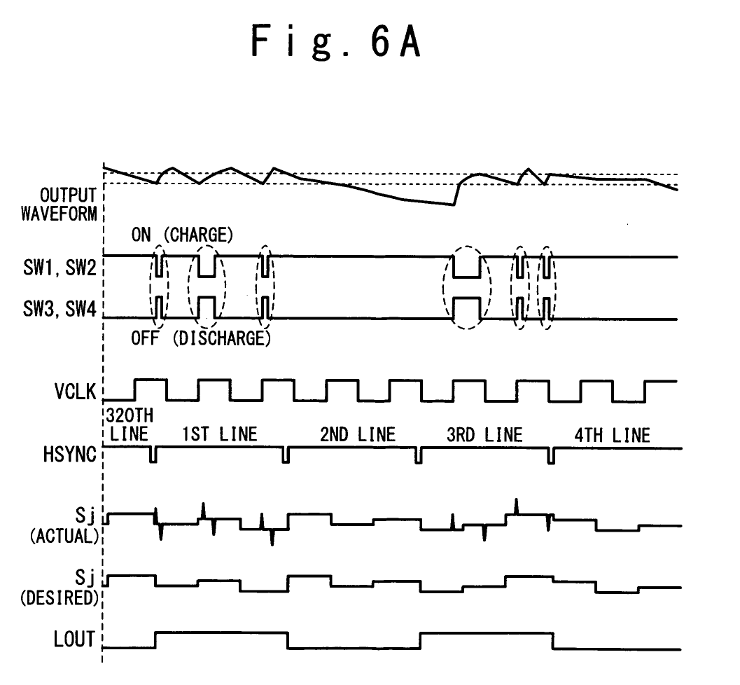

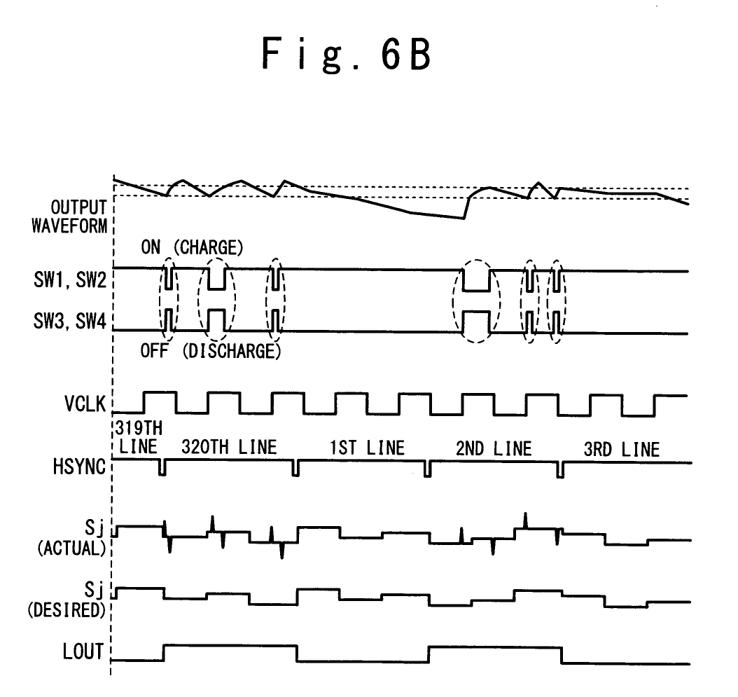

In the following, a description is given of an exemplary operation of the booster circuit 40 with reference to FIGS. 4, 5, 6A and 6B. FIG. 5 is a truth table showing an exemplary operation of the line number signal output circuit 91 of the pulse skipping operation controller section 90. FIGS. 6A and 6B are timing charts showing the pulse skipping operation in the booster circuit 40.

As described above, the timing controller 2 outputs to the source driver 30 the clock signal CLK, the display data DATA, the boosting clock signal VCLK (that will be described later), the horizontal synchronization signal HSYNC (that will be described later) indicative of the beginning of each horizontal period, and the frame switch signal FS indicating to switch the current frame data for the current image frame displayed on the liquid crystal display panel 10 to the next frame data. Here, the timing controller 2 activates the horizontal synchronization signal HSYNC 320 times in synchronization with the sequential data transfer of the display data DATA for the first to 320th lines to the source driver 30. The boosting clock signal VCLK is supplied to one of the input terminals of the AND circuit AND1 from the timing controller 2. The horizontal synchronization signal HSYNC and the frame switch signal FS are supplied to the input of the line number signal output circuit 91.

In the following, the state of the boosting clock signal VCLK is defined as being activated when the boosting clock signal VCLK is set to the high level (H), and as being deactivated when the boosting clock signal VCLK is set to the low level (L). The same goes for other signals.

### <Charging and Boosting Operation>

In the booster section 50, when the inverted boosting control signal is activated (or set to the high level (H)) and the boosting control signal is deactivated (or set to the low level (L)), the switches SW1 and SW2 are turned on and the switches SW3, SW4 are turned off. In this case, the booster section 50 performs a charging operation to accumulate an electric charges corresponding to the power supply voltage VDD across the boosting capacitor element C1. On the other hand, when the inverted boosting control signal is deactivated and the boosting control signal is activated, the switches SW1 and SW2 are turned off and the switches SW3 and SW4 are turned on. In this case, the booster section 50 performs the boosting operation to output the output voltage VDD2, which is generated by adding the power supply voltage VDD and the voltage across the boosting capacitor element C1, to the output voltage supply node N_{VDD2}. In the booster section 50, the output voltage VDD2 is boosted toward the voltage twice of the power supply voltage VDD by repeatedly performing the charging and boosting operation by using the boosting capacitor element C1.

### <Desired and Alarm Voltages Setting>

In the operation of the booster circuit 40, a desired voltage Vx and an alarm voltage Vy are defined. The desired and alarm voltages Vx and Vy are adjusted by the resistor elements R2, R3 and R4 as follows:

In the voltage comparator section 60, a divided voltage COMIN1 is generated on the connection node of the resistor elements R2 and R3 by voltage dividing with the resistor elements R2, R3 and R4. The divided voltage COMIN1 is fed to the inverting input terminal of the comparator COM1. The comparator COM1 compares the divided voltage COMIN1 fed to the inverting input terminal thereof with the reference voltage VREF fed to the non-inverting input terminal thereof, and outputs an output signal COMOUT indicative of the comparison result from the output terminal.

The desired voltage Vx is defined as the output voltage VDD2 for the case when the divided voltage COMIN1 is equal to the reference voltage VREF. The desired voltage Vx is adjusted between the reference voltage VREF and the voltage twice as high as the power supply voltage VDD. In other words, it holds:

VREF<Vx<2×VDD.

In the voltage comparator section 80, a divided voltage COMIN2 is generated on the connection node of the resistor elements R2 and R4 by voltage dividing with the resistor elements R2, R3 and R4. The divided voltage COMIN2 is supplied to the inverting input terminal of the comparator COM2. The comparator COM2 compares the divided voltage COMIN2 fed to the inverting input terminal with the reference voltage VREF fed to the non-inverting input terminal, and outputs an output signal COMOUT2 indicative of the comparison result from the output terminal.

The alarm voltage Vy is defined as the output voltage VDD2 for the case when the divided voltage COMIN2 is equal to the reference voltage VREF. The alarm voltage Vy is adjusted between the reference voltage VREF and the desired voltage Vx. That is, it holds:

VREF<Vy<Vx.

For example, the alarm voltage Vy may be 5.3 (V), when the desired voltage Vx is 5.5 (V).

### <Unconditional Boosting and Charging Operations>

In the following, a description is given of the operation of the booster circuit 40 for the case where the output voltage VDD2 is lower than the alarm voltage Vy.

When the output voltage VDD2 is reduced below the alarm voltage Vy in the voltage comparator section 80, the divided voltage COMIN2 is also reduced below the reference voltage VREF; (COMIN2<VREF). In this case, the comparator COM2 pulls up the signal level of the output signal COMOUT2 to the high level (H). In the pulse skipping operation controller section 90, the OR circuit OR1 pulls up the signal level of the output signal to the high level (H).

In the boosting controller section 70, the AND circuit AND1 outputs the boosting clock signal VCLK as it is from the output terminal in response to the output signal from the OR circuit OR1 being set to the high level (H). The inverter 71 inverts the boosting clock signal VCLK, and outputs the inverted boosting clock signal. The first level shifter 72a of the level shift circuit 72 provides level-shifting for the inverted boosting clock signal to output the inverted boosting control signal to the switches SW1 and SW2. The second level shifter 72b of the level shift circuit 72 provides level-shifting for the boosting clock signal VCLK to output the boosting control signal to the switches SW3 and SW4.

When the boosting clock signal VCLK is pulled up to the high level (H), the boosting control signal is set to the high level (H) and the inverted boosting control signal is set to the low level (L). In this case, the switches SW3 and SW4 are turned on and the switches SW1 and SW2 are turned off. When the boosting clock signal VCLK is pulled down to the low level (L), on the other hand, the boosting control signal is set to the low level (L) and the inverted boosting control signal is set to the high level (H). In this case, the switches SW1 and SW2 are turned on and the switches SW3 and SW4 are turned off. The boosting clock signal VCLK are cyclically pulled up and down and this allows boosting the output voltage VDD2 by using the boosting capacitor element C1.

In this way, when the output voltage VDD2 falls below the alarm voltage Vy, the signal level of the output signal COMOUT2 outputted from the comparator COM2 is the high level (H) and thereby the signal level of the output signal outputted from the OR circuit OR1 is also fixed to the high level (H). As a result, the above-mentioned charging and boosting operations are performed by using the boosting capacitor element C1 and thereby the booster section 50 boosts the output voltage VDD2 until the output voltage VDD2 exceeds the alarm voltage Vy. In this case, the pulse skipping operation is not performed.

### <Selective Charging and Boosting Operations>

When the output voltage VDD2 is higher than the alarm voltage Vy, charging and boosting operations are performed to regulate the output voltage VDD2 to the desired voltage Vx. It should be noted that charging and boosting operations are selectively performed not only in response to the voltage level of the output voltage VDD2, but also in response to whether the currently selected line is an even-numbered line or an odd-numbered line and whether the current image frame is an even-numbered image frame or an odd-numbered image frame.

In this embodiment, for odd-numbered image frames, charging and boosting operations are prohibited regardless of the output voltage VDD2 when an even-numbered line of the dot pixels 11 (or the even-numbered gate line G2i) is selected. For even-numbered image frames, charging and boosting operations are prohibited regardless of the output voltage VDD2, when an odd-numbered line is selected. Such operations effectively reduce the number of times of performing charging and boosting operations, and thereby reduce the noise resulting from the switching of the switches SW1 to SW4.

It should be noted that the terms “odd-numbered” and “even-numbered” are used only to distinguish two adjacent lines or two adjacent image frames. For example, in an alternative embodiment, for odd-numbered image frames, charging and boosting operations are prohibited regardless of the output voltage VDD2 when an even-numbered line of the dot pixels 11 (or the even-numbered gate line G2i) is selected. For even-numbered image frames, charging and boosting operations are prohibited regardless of the output voltage VDD2, when an odd-numbered line is selected. Such operations effectively reduce the number of times of performing charging and boosting operations, and thereby reduce the noise resulting from the switching of the switches SW1 to SW4.

In the following, a description is given of an exemplary operation of the booster circuit 40 for the case when the output voltage VDD2 is higher than the alarm voltage Vy.

When the output voltage VDD2 exceeds the alarm voltage Vy, the divided voltage COMIN2 exceeds the reference voltage VREF in the voltage comparator section 80. In this case, the comparator COM2 sets the output signal COMOUT2 to the low level (L).

When the output voltage VDD2 is further increased to exceed the desired voltage Vx, on the other hand, the divided voltage COMIN exceeds the reference voltage VREF for reference in the voltage comparator section 60. In this case, the comparator COM1 sets the output signal COMOUT to the low level (L) to instruct to perform a pulse skipping operation.

In the pulse skipping operation controller section 90, the line number signal output circuit 91 monitors and counts the horizontal synchronization signal HSYNC and the frame switch signal FS to thereby identify which line is currently selected and which image frame is currently displayed on the liquid crystal display panel 10, and outputs the output signal LOUT indicating the monitoring result. It should be noted that the liquid crystal display panel 10 includes 320 lines of the dot pixels 11, and the display data DATA for one image frame includes the display data DATA for the first to 320-th lines in this embodiment. When feeding the display data DATA for the first to 320th lines in this order, the timing controller 2 activates the horizontal synchronization signal HSYNC 320 times. The dot pixels 11 in the first to 320th lines on the liquid crystal display panel 10 are sequentially driven in response to the display data DATA associated therewith in response to the horizontal synchronization signal HSYNC being activated.

The line number signal output circuit 91 determines from the frame switch signal FS whether the current image frame is an odd-numbered image frame (1st, 3rd, 5th, . . . image frame) or an even-numbered image frame.

In addition, the line number signal output circuit 91 determines from the horizontal synchronization signal HSYNC whether the currently-selected line is an odd-numbered line (1st, 3rd, 5th, . . . , or 319th line) or an even-numbered line (2nd, 4th, 5th, . . . , or 320th line).

For the odd-numbered image frames (n-th, (n+2)-th, . . . , for an odd number n), the line number signal output circuit 91 pulls up the output signal LOUT to the high level (H) to allow charging and discharging operations, when the currently-selected line is an odd-numbered line (the 1st, 3rd, . . . , or 319th line), and pulls down the output signal LOUT to the low level (L) when the currently-selected line is an even-numbered line (the 2nd, 4th, . . . , or 320th line).

For even even-numbered image frames ((n+1)-th, (n+3)-th, . . . ), on the other hand, the line number signal output circuit 91 pulls down the output signal LOUT to the low level (L) when the currently-selected line is an odd-numbered line (the 1st, 3rd, . . . , or 319th line), and pulls up the output signal LOUT to the high level (H) to allow charging and discharging operations, when the currently-selected line is an even-numbered line (the 2nd, 4th, . . . , or 320th line).

In the pulse skipping operation controller section 90, the AND circuit AND2 is responsive to the output signal COMOUT from the comparator COM1 and the output signal LOUT from the line number signal output circuit 91 for generating the output signal LOUT2 from the output thereof. When the output signal LOUT from the line number signal output circuit 91 is set to the high level (H), the AND circuit AND2 sets the signal level of the output signal LOUT2 thereof to be identical to that of the signal level of the output signal COMOUT.

More specifically, when the output signal LOUT from the line number signal output circuit 91 is set to the high level (H) and the output signal COMOUT of the comparator COM1 is set to the low level (L), the AND circuit AND2 sets the output signal LOUT2 thereof to the low level (L). In this case, the OR circuit OR1 set the output signal thereof to the low level (L), since the signal level of the output signals COMOUT2 and LOUT2 are both set to the low level. As a result, the AND circuit AND1 in the boosting controller section 70 fixes the output signal thereof to the low level (L). In response to the output signal of the AND circuit AND1 being fixed to the low level (L), the pulse skipping operation is performed. In detail, the level shifter 72a within the level shift circuit 72 fixes the inverted boosting control signal to the high level (H), and the level shifter 72b within the level shift circuit 72 fixes the boosting control signal to the low level (L). As a result, the switches SW1 and SW2 are fixed to the ON state, and the switches SW3 and SW4 are fixed to the OFF state. This results in performing the pulse skipping operation, in which charging and boosting operations by using the boosting capacitor C1 are not performed.

When the output signal LOUT from the line number signal output circuit 91 is set to the high level (H) and the output signal COMOUT of the comparator COM1 is set to the high level (H), the AND circuit AND2 set the output signal LOUT2 there of to the high level (H). In this case, the OR circuit OR1 set the output signal thereof to the high level (H). As a result, the AND circuit AND1 in the boosting controller section 70 repeatedly switches the signal level of the output signal thereof between the high and low levels in response to the boosting clock signal VCLK. In response to the output signal of the AND circuit AND1, charging and boosting operation is performed. In detail, the level shifters 72a and 72b within the level shift circuit 72 repeatedly switches the boosting control signal and the inverted boosting control signal between the high and low levels so that the boosting control signal and the inverted boosting control signal are complementary. As a result, the switches SW1 to SW4 are repeatedly turned on and off. This results in performing charging and boosting operations by using the boosting capacitor C1 to boost the output signal VDD2.

When the output signal LOUT from the line number signal output circuit 91 is set to the high level (L), on the other hand, the AND circuit AND2 sets the output signal LOUT2 thereof to the low level (L), regardless of the signal level of the output signal COMOUT from the comparator COM1. In this case, the OR circuit OR1 set the output signal thereof to the low level (L), since the signal level of the output signals COMOUT2 and LOUT2 are both set to the low level. As a result, the AND circuit AND1 in the boosting controller section 70 fixes the output signal thereof to the low level (L). In response to the output signal of the AND circuit AND1 being fixed to the low level (L), the pulse skipping operation is performed to stop the charging and boosting operations by using the boosting capacitor C1.

As thus described, when the output voltage VDD2 exceeds the alarm voltage Vy, the output signal COMOUT2 outputted from the comparator COM2 is set to the low level (L), the OR circuit OR1 sets the signal level of the output signal thereof to be identical to that of the output signal LOUT2. Moreover, when the output signal COMOUT is set to the high level (H), the signal level of the output signal LOUT2 is set to be identical to that of the output signal COMOUT. Therefore, the output signal COMOUT from the comparator COM1 is valid, only when the output voltage VDD2 exceeds the alarm voltage Vy and the output signal LOUT from the line number signal output circuit 91 is set to the high level (H). Therefore, the above-described selective pulse skipping operation is performed when the output voltage VDD2 exceeds the desired voltage Vx and the output signal COMOUT is set to the low level (L). In detail, the pulse skipping operation is performed for the odd-numbered image frames (n-th, (n+2)-th, . . . , where n is an odd number) only when the currently selected line is an odd-numbered line (1st, 3rd, . . . , or 319th line). For the even-numbered image frames ((n+1)-th, (n+3)-th, . . . ,), on the other hand, the pulse skipping operation is performed only when the currently selected line is an even-numbered line (2nd, 4th, . . . , or 320th line). When the output voltage VDD2 exceeds the alarm voltage Vy and the output signal LOUT from the line number signal output circuit 91 is set to the low level (L), on the other hand, the pulse skipping operation is performed, regardless of the output signal COMOUT from the comparator COM1.

One may consider that there is a problem that the output level of the output voltage VDD2 is excessively decreased due to the reduction of times of performing charging and boosting operations in the booster circuit 40 of this embodiment, because charging and boosting operations are not performed when the output signal LOUT is set to the low level with the output voltage VDD2 increased above the alarm voltage Vy. It should be noted, however, that the output level of the output voltage VDD2 can be increased by adjusting the frequency of the boosting clock signal VCLK. In this embodiment, it is assumed that the frequency of the boosting clock signal VCLK is appropriately adjusted.

### <Advantageous Effect>

In the following, a description is given of an advantage of the TFT liquid crystal display device 1 of this embodiment. The TFT liquid crystal display device 1 of this embodiment effectively reduces the noise resulting from the switching of the switches SW1 to SW4, by allowing performing charging and discharging operations only when the currently selected line is an odd-numbered line or only when the currently selected line is an even-numbered line, for each image frame. This allows reducing the number of times of switching the switches SW1 to SW4 to about half of a conventional charge pump booster circuit.

In detail, in the case of the output voltage VDD2 is regulated by the pulse skipping operation, as shown in FIGS. 6A and 6B, the switches SW1 to SW4 of the booster section 50 of the booster circuit 40 operate at undefined frequencies in response to the boosting clock signal VCLK, depending on the output level of the output voltage VDD2 outputted from the booster circuit 40. In other words, since the load current of the output voltage VDD2 is not constant, the inclination of the lowering curve of the output voltage VDD2 is also not constant. Therefore, the turn-on-and-off cycles of the switches SW1 to SW4 are not fixed.

The MOS transistor switches SW1 to SW4, which are low-voltage elements, need to be of low impedance, since currents for charging/discharging the boosting capacitor element C1 transiently flow through these switches SW1 to SW4. This potentially requires enlarging channel widths of the MOS transistor switches SW1 to SW4 in the chip layout. The increase in the channel width of a MOS transistor is undesirable in terms of the parasitic capacitance the area efficiency. Then, a transistor with a large channel width may be realized by parallel connecting sources and drains of several transistors; however, this undesirably increases the number of interconnections and the load capacitance. Thus, operations of the switches SW1 to SW4, which inevitably have large channel widths, at undefined frequencies undesirably generates noise in the chip. The turn-on-and-off of the switches SW1 to SW4 undesirably cause voltage spikes to be superposed on the output grayscale voltages, and due to the voltage spikes, the data lines S1 to S240 suffer from noise.

The configuration of the booster circuit 40 of this embodiment effectively reduces the number of times of the switching of the switches SW1 to SW4, and thereby reduces the noise on the output grayscale voltages.

It is apparent that the present invention is not limited to the above embodiments, but may be modified and changed without departing from the scope of the invention.

In the above-described embodiment, the respective signals are defined as being activated when the signal of interest is set to the high level (H) and as being deactivated when the signal of interest is set to the low level (L); however, the person skilled in the art would appreciate that the respective signals may be defined as being activated when the signal of interest is set to the low level (L) and as being deactivated when the signal of interest is set to the high level (H). The logic states within the booster circuit 40 may be inverted in implementing the present invention.

Moreover, although the booster circuit 40 is integrated within the source driver 30 in the above-described embodiment, the booster circuit 40 may be integrated within the gate driver 20 for configuration simplicity in feeding the horizontal synchronization signal HSYNC and the frame switch signal FS from the timing controller 2 to the gate driver 20.

What is claimed is:

1. A booster circuit comprising:
A boosting section including a boosting capacitor element, said boosting section configured to perform charging operation to accumulate charges across said boosting capacitor element and to perform boosting operation to boost an output voltage by using charges accumulated in said boosting capacitor element; and
a control circuitry controlling said boosting section to alternately perform said charging and boosting operations in response to a boosting clock signal and said output voltage,
wherein said control circuitry prohibits performing said charging and boosting operations in response to whether a selected line of dot pixels is an odd-numbered line or an even-numbered line in a display panel.

2. The booster circuit according to claim 1,
wherein said control circuitry allows said charging and boosting operations for an even-numbered image frame when said selected line is one of odd-numbered and even-numbered lines, and
wherein said control circuitry allows said charging and boosting operations for an odd-numbered image frame adjacent to said even-numbered image frame when said selected line is the other of said odd-numbered and even-numbered lines.

3. The booster circuit according to claim 2,
wherein said control circuitry receives a horizontal synchronization signal indicative of a beginning of each horizontal period and
wherein said control circuitry prohibits performing said charging and boosting operations in response to said horizontal synchronization signal.

4. The booster circuit according to claim 3,
wherein said control circuitry receives a frame switch signal indicative of switching of image frames, and
wherein said control circuitry prohibits performing said charging and boosting operations in response to said frame switch signal.

5. The booster circuit according to claim 1,
wherein said boosting controller section controls said booster section to perform said charging operation in response to said boosting clock signal being set to one of activated and deactivated states, and
wherein said boosting controller section controls said booster section to perform said boosting operation in response to said boosting clock signal being set to the other of said activated and deactivated states.

6. A driver comprising:
a booster circuit outputting a boosted output voltage;
a grayscale voltage generator operating on said boosted output voltage to generate a set of grayscale voltages;
a digital-analog converter selecting output grayscale voltages corresponding to display data from said set of grayscale voltages; and
an amplifier circuit operating on said boosted output voltage to output said selected output grayscale voltages to a display panel,
wherein said booster circuit includes:
a boosting section comprising a boosting capacitor element, said boosting section configured to perform charging operation to accumulate charges across said boosting capacitor element and to perform boosting operation to boost said output voltage by using charges accumulated in said boosting capacitor element; and
a control circuitry controlling said boosting section to alternately perform said charging and boosting operations in response to a boosting clock signal and said output voltage,
wherein said control circuitry prohibits performing said charging and boosting operations in response to whether a selected line of dot pixels is an odd-numbered line or an even-numbered line in a display panel.

7. The driver according to claim 6, wherein said control circuitry allows said charging and boosting operations for an even-numbered image frame when said selected line is one of odd-numbered and even-numbered lines, and
wherein said control circuitry allows said charging and boosting operations for an odd-numbered image frame adjacent to said even-numbered image frame when said selected line is the other of said odd-numbered and even-numbered lines.

8. The driver according to claim 7, wherein said control circuitry receives a horizontal synchronization signal indicative of a beginning of each horizontal period and
wherein said control circuitry prohibits performing said charging and boosting operations in response to said horizontal synchronization signal.

9. The driver according to claim 8, wherein said control circuitry receives a frame switch signal indicative of switching of image frames, and
wherein said control circuitry prohibits performing said charging and boosting operations in response to said frame switch signal.

10. The driver according to claim 6, wherein said boosting controller section controls said booster section to perform said charging operation in response to said boosting clock signal being set to one of activated and deactivated states, and
wherein said boosting controller section controls said booster section to perform said boosting operation in response to said boosting clock signal being set to the other of said activated and deactivated states.

11. A display device comprising:
a booster circuit outputting a boosted output voltage;
a driver; and
a display panel,
wherein said driver comprising:
a grayscale voltage generator operating on said boosted output voltage to generate a set of grayscale voltages;
a digital-analog converter selecting output grayscale voltages corresponding to display data from said set of grayscale voltages; and
an amplifier circuit operating on said boosted output voltage to output said selected output grayscale voltages to a display panel,
wherein said booster circuit includes:
a boosting section comprising a boosting capacitor element, said boosting section configured to perform charging operation to accumulate charges across said boosting capacitor element and to perform boosting operation to boost said output voltage by using charges accumulated in said boosting capacitor element; and
a control circuitry controlling said boosting section to alternately perform said charging and boosting operations in response to a boosting clock signal and said output voltage,
wherein said control circuitry prohibits performing said charging and boosting operations in response to whether a selected line of dot pixels is an odd-numbered line or an even-numbered line in a display panel.

12. The display device according to claim 11, wherein said control circuitry allows said charging and boosting operations for an even-numbered image frame when said selected line is one of odd-numbered and even-numbered lines, and
wherein said control circuitry allows said charging and boosting operations for an odd-numbered image frame adjacent to said even-numbered image frame when said selected line is the other of said odd-numbered and even-numbered lines.

13. The display device according to claim 12,
wherein said control circuitry receives a horizontal synchronization signal indicative of a beginning of each horizontal period and
wherein said control circuitry prohibits performing said charging and boosting operations in response to said horizontal synchronization signal.

14. The display device according to claim 13,
wherein said control circuitry receives a frame switch signal indicative of switching of image frames, and
wherein said control circuitry prohibits performing said charging and boosting operations in response to said frame switch signal.

15. The display device according to claim 11,
wherein said boosting controller section controls said booster section to perform said charging operation in response to said boosting clock signal being set to one of activated and deactivated states, and
wherein said boosting controller section controls said booster section to perform said boosting operation in response to said boosting clock signal being set to the other of said activated and deactivated states.

16. A method of voltage boosting, comprising:
alternately performing a charging operation to accumulate charges across a boosting capacitor element and a boosting operation to boost an output voltage by using charges accumulated in said boosting capacitor element in response to a boosting clock signal and said output voltage; and
prohibiting performing said charging and boosting operations in response to whether a selected line of dot pixels is an odd-numbered line or an even-numbered line in a display panel.

17. The method according to claim 16, further comprising:
allowing said charging and boosting operations for an even-numbered image frame when said selected line is one of odd-numbered and even-numbered lines; and
allowing said charging and boosting operations for an odd-numbered image frame adjacent to said even-numbered image frame when said selected line is the other of said odd-numbered and even-numbered lines.

18. The method according to claim 17, further comprising:
receiving a horizontal synchronization signal indicative of a beginning of each horizontal period,
wherein said charging and boosting operations are prohibited in response to said horizontal synchronization signal.

19. The method according to claim 18, further comprising:
receiving a frame switch signal indicative of switching of image frames,
wherein said charging and boosting operations are prohibited in response to said frame switch signal.

20. The method according to claim 16, wherein said charging operation is performed in response to said boosting clock signal being set to one of activated and deactivated states, and
wherein said boosting operation is performed in response to said boosting clock signal being set to the other of said activated and deactivated states.
